(19) United States
(12) Patent Application Publication
(10) Pub. No.: US 2007/0279656 A1
(43) Pub. Date: Dec. 6, 2007

(54) Image forming system and output device management method

(75) Inventors: Yasuki Yamauchi, Kanagawa (JP); Ryosuke Higashikata, Kanagawa (JP); Akihiro Ito, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/640,902

(22) Filed: Dec. 19, 2006

(30) Foreign Application Priority Data
Jun. 5, 2006 (JP) 2006-156193

(51) Int. Cl. G06F 15/00

(52) U.S. Cl. 358/1.9; 358/448

(57) ABSTRACT

The present invention provides an image forming system. The image forming system includes at least a first color gamut information retaining component, a device information obtaining component, a color gamut information computing component, a comparison component and a judgment component. The color gamut information computing component computes second color gamut information that is a necessary gamut for image formation based on the image data to be output to an output device. The comparison component compares the second color gamut information computed by the color gamut information computing component and first color gamut information representing the color gamut that can be formed by the output device obtained by the device information obtaining component. The judgment component that judges based on the comparison result of the comparison component whether or not to output the image data to the output device to perform an image forming process.

### BACKGROUND

1. Technical Field

The present invention relates to an output device such as an image forming device which records an image on recording sheets according to image data, particularly to an output device management method by which the desired image can be formed with the output device when an image processing device such as a personal computer and the output device are connected to each other while bi-directional communication can be performed, and the image forming system.

2. Related Art

In addition to displays such as CRT and LCD, image forming devices such as a print output device which forms the image on a recording medium such as the recording sheets according to the image data by applying an electrophotographic process can be listed as an example of the output device for forming the image according to image data.

In the print output device, toner images having colors C (Cyan), M (Magenta), Y (Yellow), and K (Black) are transferred to the recording sheet based on the image data using the color toners of C, M, Y, and K, the toner images are fixed to the recording sheet by heating or pressurizing the toner images, and thereby a full-color image is formed according to the image data.

The image data of an RGB color space is used in the image data of the image read by a scanner and in the image data which is generated by performing image processing such as image creation and edit with the image processing device such as the personal computer and a workstation. On the other hand, the print output device deals with image data (CMYK data) of a CMYK color space.

Therefore, a color management system (CMS) is provided in the print output device. The CMS converts the RGB data into data of an L*a*b* color space which is of a device-independent color space using a previously created color data conversion profile such as an ICC profile, and then the CMS converts the data of the L*a*b* color space into the data of the CMYK color space which is of a color space dependent on the output-side device.

In a device initial state of the print output device, each color is made reproducible maximum density, and a reproducible color gamut is calculated based on the maximum density. However, as the image forming processes are repeatedly performed, the reproducible color gamut is gradually narrowed due to various factors. A resultant difference in color gamuts between the print output device and the color data conversion profile causes the image to be hardly formed according to the image data.

Therefore, in the print output device, a calibration process is performed at predetermined timing, which updates the color data conversion profile corresponding to the color gamut of the print output device.

On the other hand, although the color data conversion profile corresponding to the color gamut of the print output device is obtained at that time by performing the calibration, the reproducible color gamut becomes narrowed compared with the device initial state in the print output device.

Therefore, in the case where the color gamut of the image data inputted to the print output device differs from the color gamut of the print output device, sometimes color reproduction is performed according to the image data by performing a color gamut compression process, i.e., gamut mapping to the inputted image data such that the color gamut of the inputted image data becomes the color gamut of the print output device.

However, when the color gamut is largely narrowed, chroma is decreased in the image and the color reproduction becomes difficult according to the image data, even if not only the color data conversion profile is updated by the calibration but also gamut mapping is performed.

In order to recover the color gamut of the print output device to the device initial state, it is necessary to perform setup of the device. The setup process is generally performed by an operator as a maintenance operation. Alternatively, the setup process can automatically be performed by the device itself.

The print output device can be returned to the device initial state by performing the setup process, and the image can be formed in the color gamut which is originally possessed by the device (for example, the image having the maximum density in each color). However, when the setup processes are frequently performed, an operating rate is decreased while consumption of expendable supplies increases, which results in the increase in running cost of the device.

### SUMMARY

According to an aspect of the invention, there is provided an image forming system. The image forming system includes an image processing device, an output device, a first color gamut information retaining component, a device information obtaining component, a color gamut information computing component, a comparison component and a judgment component. The image processing device carries out image processing including image formation. The output device forms an image according to image data within an image-formable color gamut by receiving the image data output from the image processing device. The first color gamut information retaining component is provided in the output device and retains first color gamut information representing the color gamut which can be formed by the output device. The device information obtaining component is provided in the image processing device and obtains the first color gamut information from the output device. The color gamut information computing component computes second color gamut information, which is necessary gamut for image formation based on the image data to be output to the output device. The comparison component compares the second color gamut information computed by the color gamut information computing component and the first color gamut information obtained by the device information obtaining component. The judgment component judges whether or not the image data is outputted to the output device to perform an image forming process based on the comparison result of the comparison component.

### BRIEF DESCRIPTION OF THE DRAWINGS

An exemplary embodiment of the present invention will be described in detail based on the following figures, wherein:

FIG. 1 is a schematic diagram showing an image forming system according to an exemplary embodiment of the present invention;

FIG. 2 is a block diagram showing schematic configurations of main parts of a personal computer and a printer according to an exemplary embodiment of the present invention;

FIG. 3 is a view showing a schematic configuration of a print output unit;

FIG. 4 is a schematic view showing a part of color gamut of the printer and an example of color gamut of image data corresponding to the color gamut of the printer;

FIG. 5 is a flowchart schematically showing an image forming process performed by a personal computer;

FIG. 6A is a schematic view showing an example of UI applied to the process in the personal computer, wherein an example of a warning confirmation window for demanding a setup process is showed; and

FIG. 6B is a schematic view showing an example of UI applied to the process in the personal computer, wherein an example of a process confirmation window for setting either continuation of a print process or performance of the setup process is showed.

### DETAILED DESCRIPTION

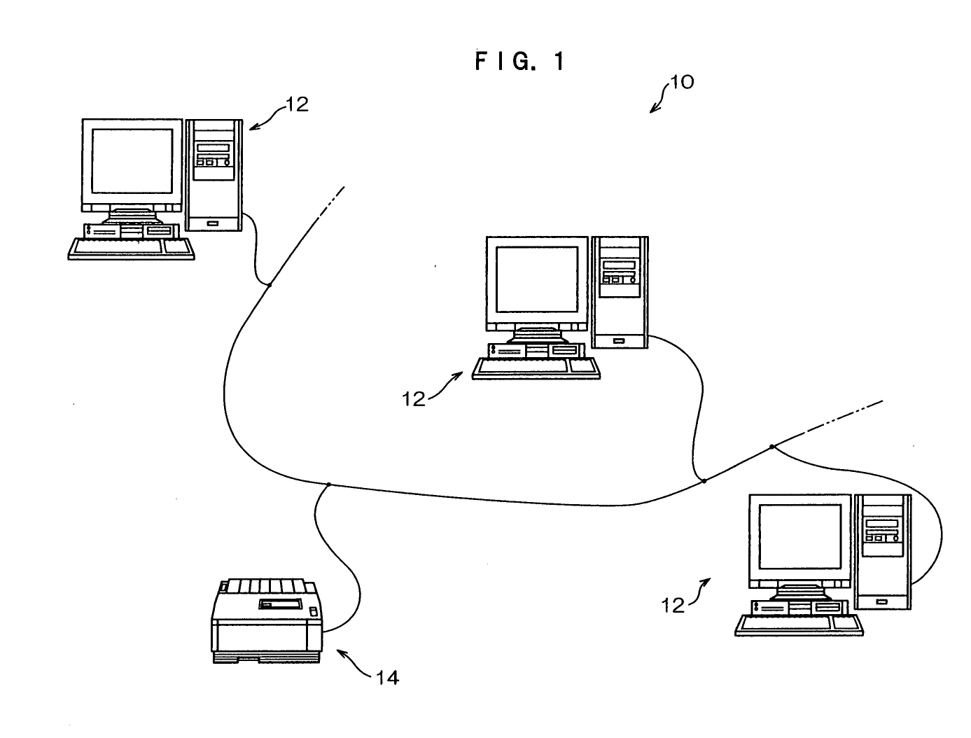

An exemplary embodiment of the present invention will be described below with reference to the accompanying drawings. FIG. 1 shows a schematic configuration of an image forming system according to an exemplary embodiment of the present invention. An image forming system 10 includes plural image processing devices (hereinafter abbreviated to PC 12) such as personal computers and workstations and a printer 14 which is of the output device. Network connection is established between PC 12 and the printer 14.

PC 12 can perform various processes including image processing such as creation, edit, and processing of an image, a document or the like. PC 12 can perform bi-directional device communication not only with the printer 14 which is of the output device but also with other output devices and input devices.

Therefore, in the image forming system 10, data (hereinafter referred to as image data) such as the image or document created by PC 12 is transmitted as a print job to the printer 14, and the printer 14 performs an image forming process (print process) according to the image data of the print job. At the same time, PC 12 can obtain the status of the printer 14 which is of the output device at arbitrary timing.

In the image forming system 10, the network connection is established between the printer 14 and each of the plural PCs 12 while bi-directional device communication can be performed. In the image forming system 10, plural printers 14 may be provided, and another kind of output device or input device may arbitrarily be connected to the network.

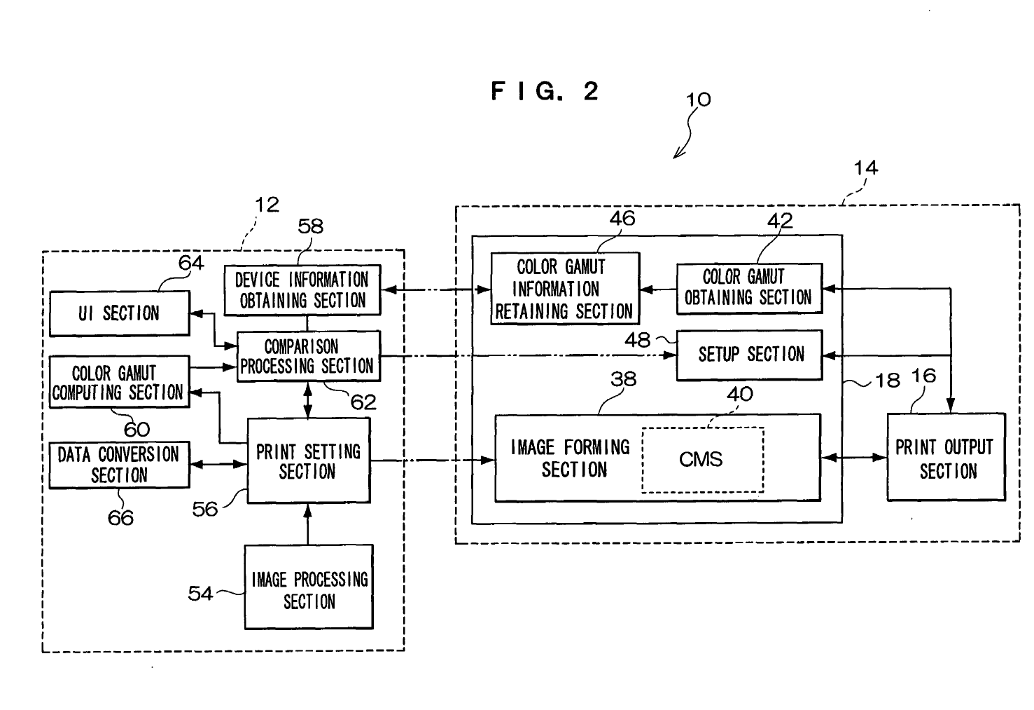

As shown in FIG. 2, the printer 14 includes a print output unit 16 which is of a print engine unit for performing the print process and a controller unit 18 which controls an operation of the print output unit 16. The image data outputted from PC 12 is inputted to the controller unit 18, a predetermined process is performed to the image data, and then the print output unit 16 performs the image forming process. A printer which has at least a printer function (image forming function) can be used as the printer 14. For example, a multi function peripheral which has an image reading function in addition to the printer function or a multi function peripheral which further has a facsimile function can arbitrarily used as the printer 14.

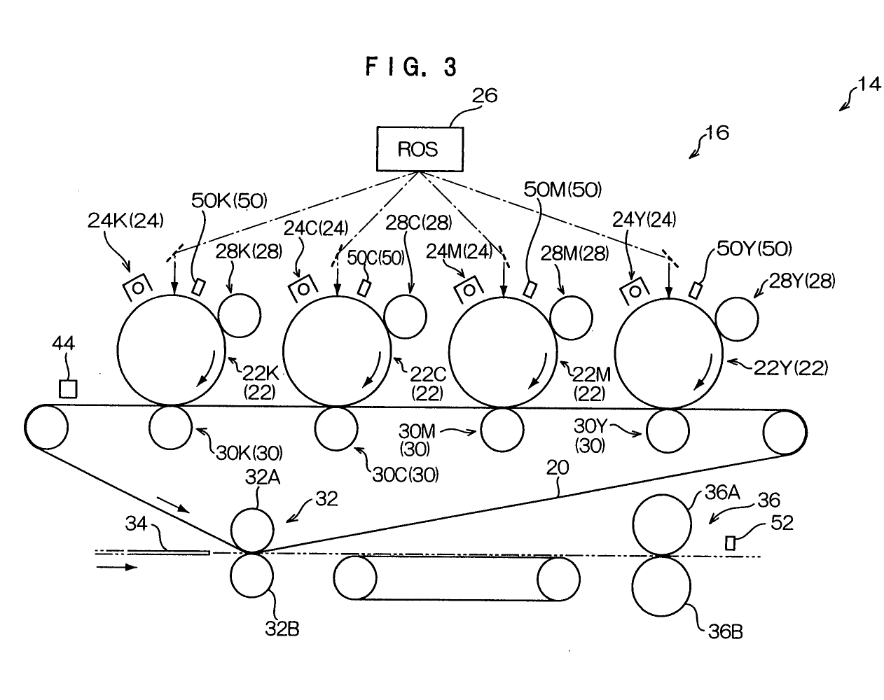

FIG. 3 shows a schematic configuration of a main part of the print output unit 16. An endless transfer belt 20 which is of an intermediate transfer body is provided in the print output unit 16, and plural photosensitive drums 22 which are of an image bearing body face the transfer belt 20. A full-color image can be formed in the printer 14 with four-color toners of Y (Yellow), M (Magenta), C (Cyan), and K (Black). A photosensitive drum 22Y for Y color, a photosensitive drum 22M for M color, a photosensitive drum 22C for C color, and a photosensitive drum 22K for K color (hereinafter referred to as photosensitive drum 22 in collective expression) are provided as the photosensitive drum 22 in the print output unit 16.

A charging device 24 (charging devices 24Y, 24M, 24C, and 24K) faces a peripheral surface of each photosensitive drum 22, and the photosensitive drum 22 is uniformly charged by the charging device 24.

ROS (Raster Optical Scanner) 26 which is of a scanning and exposing component is provided in the print output unit 16. ROS 26 emits a light beam such as a laser beam toward the peripheral surface of the charged photosensitive drum 22. At this point, ROS 26 emits the light beam based on the data of each of color components Y, M, C, and K, which allows the scanning and exposure to be performed to the photosensitive drums 22Y, 22M, 22C, and 22K.

A developing device 28 (developing devices 28Y, 28M, 28Y, and 28K) which supplies the corresponding color toner faces the peripheral surface of the photosensitive drum 22. In the photosensitive drum 22, a toner image is formed according to an electrostatic latent image by the toner supplied from the developing device 28.

A transfer device (30Y, 30M, 30C, and 30K) also faces the photosensitive drum 22, and the toner image formed on the photosensitive drum 22 by the transfer device 30 is transferred to the transfer belt 20.

In the print output unit 16, the toner images formed on the photosensitive drums 22Y, 22M, 22C, and 22K are transferred to the transfer belt 20 while overlapped on one another, which allows a full-color toner image to be formed on the transfer belt 20. In order to remove the residual toner to uniformly charge the photosensitive drums 22, a cleaner for removing the toner remaining on the peripheral surface and a static eliminator for eliminating electricity on the peripheral surface of each of the photosensitive drums 22 in which the transfer is ended.

A transfer device 32 is provided in the print output unit 16. The transfer device 32 includes a pair of rollers 32A and 32B which is arranged while nipping the transfer belt 20. A recording sheet 34 which is of a recording medium is used in the print output unit 16, and the image is formed on the recording sheet 34. The recording sheet 34 taken out from a sheet feeding unit is delivered to the nip between the rollers 32A and 32B in synchronization with the movement of the toner image transferred onto the transfer belt 20.

The toner image is overlapped on the recording sheet 34 and held between the rollers 32A and 32B, which allows the toner image to be transferred from the transfer belt 20 to the recording sheet 34.

A fixing device 36 is provided in the print output unit 16, and the fixing device 36 includes a heating roller 36A and a pressurizing roller 36B. The fixing device 36 sends out the recording sheet 34, to which the toner image is transferred, while the recording sheet 34 is held between the heating roller 36A and the pressurizing roller 36B. Therefore, the toner image is fused and fixed to form the image on the recording sheet 34 according to the image data.

In the exemplary embodiment, the printer 14 including the print output unit 16 which forms the image by a so-called tandem manner is described by way of example. However, the present invention is not limited to the printer 14, but an image forming unit having an arbitrary configuration may be applied to the present invention.

On the other hand, as shown in FIG. 2, an image forming unit 38 is provided in the controller unit 18, and a color management system 40 (hereinafter abbreviated to CMS 40) is formed in the image forming unit 38.

In the print output unit 16, the toner images having colors C, M, Y, and K are formed by inputting image data (hereinafter referred to as CMYK signal) of a CMYK color space. In the image forming unit 38, image data (hereinafter referred to as RGB signal) of an RGB color space is converted into device-independent color space data, and then the device-independent color space data is converted into the CMYK signal which is of device-dependent color space data.

That is, the image forming unit 38 performs data conversion to the RGB signal into image data (hereinafter referred to as L*a*b* signal) of a CIELAB color space (hereinafter referred to as L*a*b* color space) which is of the device-independent color space. At this point, the data conversion is performed by a generally known technique in which a multi-dimensional lookup table (DLUT) is used.

CMS 40 converts the L*a*b* signal into the CMYK signal using a color data conversion profile such as an ICC profile. In the exemplary embodiment, the L*a*b* color space is used as an example of the device-independent color space. However, the present invention is not limited to the L*a*b* color space, but any color space can be applied as long as the color space is the device-independent color space. For the inputted image data, the present invention is not limited to the RGB color space data, but arbitrary color space data can be used. A color data conversion profile having an arbitrary configuration can be applied as the color data conversion profile.

A lookup table (LUT) of a parameter for converting pixel density of 256 gray levels (0 to 255) into the number of dots of one pixel is provided in the image forming unit 38. The image forming unit 38 generates raster data of each color by converting the CMYK signal obtained by the CMS 40 using the LUT conversion parameter of each color pixel, and ROS 26 emits the light beam based on the raster data.

Therefore, the printer 14 can form the image having chroma according to the image data on the recording sheet 34.

In the printer 14, a color data conversion profile, charging voltage of each charging device 24, and transfer voltages of the transfer devices 30 and 32 are set based on the maximum density which can be outputted in a device initial state. The printer 14 can form the image within the maximum density of each color. The color gamut of the image which can be formed by the printer 14 is determined by the maximum density, and the color gamut is widest in the device initial state.

That is, in the printer 14, the density of each of the colors C, M, Y, and K formed in the recording sheet 34 is changed by an output amount of the light beam, the toner used, the charged voltage of each photosensitive drum 22, and the transfer voltage of each of the transfer devices 30 and 32. The parameters such as the charged voltage and transfer voltage at which the maximum density is obtained are set in the device initial state, and the color data conversion profile used in the device initial state for the CMS 40 is set to match with the maximum density.

However, in the output device such as the printer 14, the color gamut which is of a reproducible density range is gradually narrowed due to various factors. When the color data conversion profile describes with the previous color gamut while the color gamut is narrowed, the chroma is decreased in the image formed in the recording sheet 34.

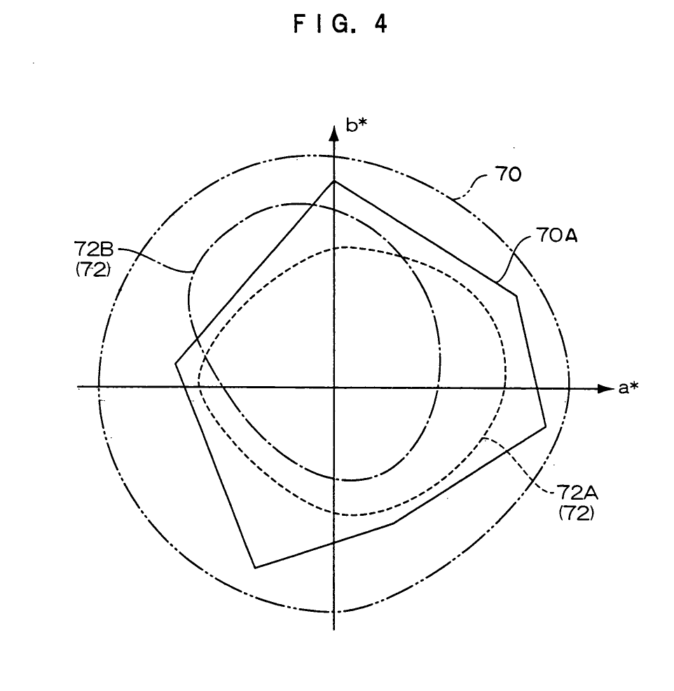

As shown in FIG. 4, the color gamut which can be outputted on the L*a*b* color space by the print output unit 16 becomes maximum values of the a* and b* values (chroma) in each hue angle (hue) to each L* value. FIG. 4 schematically shows the hue and the chroma (a*b* value) to an arbitrary L* value.

Referring to FIG. 4, L* and the maximum values of the a* and b* values in each hue angle to each L* value are also decreased in the color gamut 70A which is narrowed from the color gamut 70 in the device initial state. Therefore, the chroma of the image is decreased due to the density decrease in each pixel when the pixel is formed between the current color gamut and the color gamut shown by the color data conversion profile (for example, between the color gamut 70A and the color gamut 70).

As shown in FIG. 2, a color gamut obtaining unit 42 is provided in the controller unit 18 of the printer 14. The color gamut obtaining unit 42 obtains the color gamut of the image which can be formed at that time by the print output unit 16. As shown in FIG. 3, an image density sensor 44 which faces the transfer belt 20 is provided in the print output unit 16. The image density sensor 44 can measure the density of each of the colors R, G, and B from the toner image transferred to the transfer belt 20.

The controller unit 18 shown in FIG. 2 performs calibration at predetermined timing to obtain output characteristics of the print output unit 16 using the image density sensor 44. The color gamut obtaining unit 42 obtains color gamut information from the output characteristics. The density range which can be outputted by the print output unit 16 can be grasped with the color gamut information. The controller unit 18 also creates the color data conversion profile to update the color data conversion profile used in CMS 40 based on the output characteristics of the print output unit 16.

Therefore, the print output unit 16 performs the image forming process by the color data conversion profile according to the change in color gamut.

The calibration process is performed, when the parameter having an influence on the output characteristics of the print output unit 16, such as a print volume of the printer 14 and device operating time after the previous operation, reaches a predetermined value. In the calibration process, the toner image (patch) is formed on the transfer belt 20 based on the image data of a chart previously set for the purpose of calibration process, and the density of each of the colors R, G, and B is measured in the toner image using the image density sensor 44. Then, the controller unit 18 creates the color data conversion profile from measurement result and the image data of the chart based on the color gamut, the chroma, and the gray level, which are able to be outputted by the print output unit 16. The color gamut obtaining unit 42 obtains the reproducible color gamut as the color gamut information.

A color gamut information retaining unit 46 is provided in the controller unit 18. The color gamut information retaining unit 46 retains the color gamut information obtained by the color gamut obtaining unit 42. That is, the color gamut information retaining unit 46 retains the color gamut on the L*a*b* color space as the color gamut information, and the color gamut on the L*a*b* color space is adapted to the color gamut which can be reproduced using the color data conversion profile by the print output unit 16. The color gamut information retaining unit 46 may retains not only the color gamut information but output characteristics of the print output unit 16.

On the other hand, the color gamut of the image which can be reproduced at that time by the print output unit 16 is obtained by performing the calibration process, and the color gamut is narrower than the color gamut in the device initial state. Therefore, in the image formed by the print output unit 16, the chroma is decreased compared with the device initial state, even if the calibration process is performed.

In order to prevent the decrease in chroma, it is necessary to perform the setup process of returning the color gamut of the print output unit 16 to the device initial state.

Therefore, a setup unit 48 is provided in the controller unit 18. The setup unit 48 adjusts the output image of the print output unit 16 to the maximum density to return the output characteristics of the print output unit 16 to the device initial state. Consequently, in the printer 14, the reproducible color gamut of the print output unit 16 to the color gamut in the device initial state.

As shown in FIG. 3, in the print output unit 16, a charging potential sensor 50 (SOY, 50M, 50C, and 50K) and an image density sensor 52 are provided while facing the photosensitive drum 22 (22Y, 22M, 22C, and 22K). The charging potential sensor 50 detects the charged potential, and the image density sensor 52 detects the image density on the recording sheet 34 passing through the fixing device 36.

The setup unit 48 shown in FIG. 2 forms the toner image on the transfer belt 20 with the image data (image data on the chart image) set for the setup, and the setup unit 48 measures the density of the toner image formed on the transfer belt 20 using the image density sensor 44. The setup unit 48 measures the image density of the image in which the toner image is transferred to the recording sheet 34 using the density sensor 52, and the setup unit 48 measures the charged potential of each photosensitive drum 22 in forming the image using the charging potential sensor 50.

Then, the setup unit 48 adjusts charging balance of the charging device 24 (24Y, 24M, 24C, and 24K) and the transfer voltages of the transfer device 30 (30Y, 30M, 30C, and 30K) and transfer device 32 based on the measurement results, and the setup unit 48 updates the conversion parameters of LUT based on gray-level characteristics of each color.

The setup unit 48 repeats the process to achieve the balance of each color, and sets the charging voltage and transfer voltage such that the image having the density in the device initial state can be formed. Therefore, the controller unit 18 returns the reproducible color gamut of the print output unit 16 to the device initial state.

The controller unit 18 generates the color data conversion profile after the setup is performed to the print output unit 16, and the color gamut obtaining unit 42 obtains the color gamut information at that time to update the color gamut information obtained by the color gamut information retaining unit 46 to the latest color gamut information.

The print output unit 16 can form the image in the color gamut in the device initial state using the color data conversion profile changed in the above-described manner.

On the other hand, PC 12 provided in the image forming system 10 can perform the bi-directional device communication with the printer 14, PC 12 issues various commands to the printer 14, and the printer 14 can perform the processes according to the commands.

Therefore, when the printer 14 receives a request of color gamut information from PC 12, the color gamut information retained by the color gamut information retaining unit 46 is outputted to PC 12 which makes the request. When the printer 14 receives the command of the setup process from PC 12, the setup unit 48 performs the setup process to the print output unit 16 based on the command.

A print setting unit 56 is provided in PC 12 along with an image processing unit 54 which performs the creation, edit, and processing of the image or document with various kinds of application software. The image data which is created, edited, and processed by the image processing unit 54 can be outputted in the form of a print job to the printer 14 through the print setting unit 56.

A device information obtaining unit 58 is provided in PC 12. Because the bi-directional device communication is established between the PC 12 and the printer 14, the device information obtaining unit 58 makes a request of the color gamut information to the printer 14 at predetermined timing. The device information retaining unit 58 reads the color gamut information, when the printer 14 outputs the color gamut information retained by the color gamut information retaining unit 46 to PC 12.

That is, the device information obtaining unit 58 obtains the latest output characteristics including the color gamut information which can be reproduced at that time by the printer 14. The timing at which the device information obtaining unit 58 obtains the color gamut information from the printer 14 can arbitrarily be set. Preferably the timing includes a time when the transmission of the print job is started. The device information obtaining unit 58 may retain the obtained latest device information.

A color gamut computing unit 60 and a comparison processing unit 62 are provided in PC 12. The color gamut computing unit 60 reads the image data to compute the color gamut information (hereinafter referred to as color gamut) on the image data, when the image data is outputted in the form of the print job to the printer 14. The color gamut can be computed in the color gamut computing unit 60 by an arbitrary technique. For example, the RGB signal is converted into the L*a*b* signal using DLUT, and the a* value and the b* value are obtained from the converted L*a*b* signal in each hue angle for each L* value.

The comparison processing unit 62 reads and compares the color gamut of the image data computed by the color gamut computing unit 60 and the latest color gamut information (color gamut) on the printer 14, which is obtained by the device information obtaining unit 58.

At this point, the comparison processing unit 62 outputs the result of judgement to the print setting unit 56, when the reproducible color gamut of the printer 14 is wider than the color gamut of the image data and it is judged that the print having the chroma can be outputted according to the image data. Therefore, the print setting unit 56 outputs the image data in the form of the print job to the printer 14.

When the reproducible color gamut of the printer 14 (hereinafter referred to as color gamut of printer 14) is narrowed, sometimes the color of the image data becomes located outside the color gamut of printer 14. When the color of the image data is located outside the reproducible color gamut of printer 14, the color reproduction property and chroma are decreased.

When the small difference exists between the color gamut of the image data and the color gamut of printer 14, generally the decrease in color reproduction property and the decrease in chroma can be suppressed by performing a data conversion process such as remapping and gamut mapping to the image data.

However, when the color gamut of printer 14 is largely narrowed, it is necessary that the color gamut of printer 14 be returned to the device initial state by performing the setup process to the print output unit 16.

A user interface (UI) unit 64 is provided in PC 12. When the comparison processing unit 62 judges that the color gamut of the image data is located outside the color gamut of printer 14, PC 12 displays a predetermined UI on the display. Therefore, on the basis of the displayed UI, a user can perform an input operation whether the print process is continued or the setup process is performed to the printer 14.

That is, when the color gamut of the image data is located outside the color gamut of printer 14, the comparison processing unit 62 displays the information on the display using the UI unit 64, and the comparison processing unit 62 requests the user to confirm whether or not the print process is performed. The comparison processing unit 62 issues the command for transmitting the image data to the print setting unit 56 when the continuation of the print process is selected by the confirmation request.

Therefore, as shown in FIG. 4, assuming that the color gamut 70A is the color gamut of printer 14 which is obtained from the color gamut information on the printer 14 obtained by the device information obtaining unit 58, when the color gamut 72A is the color gamut 72 of the image data computed by the color gamut computing unit 60, the color gamut 72A of the image data is located within the color gamut 70A, so that the comparison processing unit 62 causes the print process to be performed. FIG. 4 shows a region of the a*b* value to an arbitrary L* value in the L*a*b* color space.

When the color gamut 72B is the color gamut 72 of the image data computed by the color gamut computing unit 60, because a part of the color gamut 72B is located outside the color gamut 70A, the comparison processing unit 62 confirms whether or not the print process is performed using the UI unit 64.

At this point, the comparison processing unit 62 issues the command for performing the setup process to the controller unit 18 of the printer 14, when the setup process of returning the print output unit 16 of the printer 14 to the device initial state is specified. The command for performing the setup process is inputted to the setup unit 48 of the controller unit 18, which allows the printer 14 to perform the setup process.

The comparison processing unit 62 obtains the color gamut information on the printer 14 at predetermined timing through the device information obtaining unit 58, and the comparison processing unit 62 judges whether or not the reproducible color gamut of the printer 14 is narrowed to a predetermined range from the obtained color gamut information. As a result of the judgment, when the color gamut of the printer 14 is narrowed to the predetermined range, the comparison processing unit 62 issues the command for performing the setup process to the printer 14.

The judgment whether or not the comparison processing unit 62 issues the command for performing the setup process to the printer 14 can be made by, e.g., a method in which a color gamut volume which is of a chroma distribution volume is determined from the color gamut information to compare the color gamut volume to a predetermined reference value.

The color gamut information on the printer 14 obtained by the device information obtaining unit 58 includes the color data conversion profile for converting the L*a*b* signal into the CMYK signal. The comparison processing unit 62 obtains the L*a*b* signal from the predetermined CMYK signal using the color data conversion profile, and the comparison processing unit 62 computes the color gamut volume using the L*a*b* signal.

Examples of the method of computing the color gamut volume include a method of overlapping a triangular pyramid formed by linearly connecting three points, a method of determining a calorimetric value of an outermost periphery to add an area of a two-dimensional plane (a*b* plane) while an L* axis is shredded, a computation method compatible with the institute of image electronics engineers of Japan, and known various computation methods.

When the color gamut volume of the printer 14 is computed, the comparison processing unit 62 compares the computed color gamut volume to the predetermined reference value to judge whether or not the setup is required. The comparison processing unit 62 issues the command for performing the setup process, when the color gamut volume of the printer 14 is lower than the reference value, or when the color gamut volume of the printer 14 is located within the predetermined range with respect to the reference value.

A ratio of the device initial state of the printer 14 to the color gamut volume can be used as the reference value. When the printer 14 performs the setup process based on the setup command from PC 12, the printer 14 may notify other PCs 12 connected to the printer 14 that the setup process is performed. Preferably the printer 14 notifies PCs 12 that the setup process is performed and the setup process is performed after permission of the setup process is received from each of PCs 12.

A data conversion unit 66 is provided in PC 12. In PC 12, when the continuation of the print process is selected, data conversion unit 66 performs the data conversion to the image data based on the color gamut of printer 14 and the color gamut of the image data.

That is, when the color gamut of printer 14 is narrower than the color gamut 70 in the device initial state, even if the color gamut of the image data is accommodated in the color gamut of printer 14, the chroma is decreased to no small extent in the image outputted from the printer 14.

The data conversion unit 66 forms the image with density corresponding to the image data by performing the remapping, when the color gamut of the image data is narrower than the color gamut of the print output unit 16 (for example, the color gamut 72A with respect to the color gamut 70A shown in FIG. 4).

For example, in the case where the image data having 70% density for a certain color is inputted when the color gamut of the color is decreased to 80% of the maximum density, only 56% of the original density is obtained in the directly formed image.

At this point, the data conversion unit 66 performs the remapping such that 87.5% density is obtained for pixel data of the color, and thereby the image having 70% density is obtained for the pixel when the print output is performed. In the description of the exemplary embodiment, the remapping is performed to the image data having the color gamut narrower than the color gamut of printer 14, when the color gamut of printer 14 is narrowed. However, the present invention is not limited to the exemplary embodiment, but an arbitrary data conversion method can be adopted as long as the image can be formed with the density corresponding to the image data.

On the other hand, when the color gamut of the inputted image data is wider than the color gamut being reproducible by the print output unit 16, the data conversion unit 66 performs the color gamut compression process to the input image data, and the data conversion unit 66 performs the gamut mapping in which the mapping is performed onto the color gamut being reproducible by the print output unit 16.

In the data conversion process, the RGB signal of the image data is converted into the L*a*b* signal using DLUT, the mapping process is performed to the L*a*b* signal on the Lab color space, and thereby the new Lab signal (for example, L*a*b* signal) is obtained. Then, the image data in which the L*a*b* signal is accommodated in the color gamut of printer 14 is generated by converting the L*a*b* signal into the RGB signal.

Thus, the image data to which the data conversion is performed is outputted to the printer 14, which allows the image to be formed with the desired color reproduction property and chroma when the reproducible color gamut of the printer 14 becomes narrowed. In this case, the data conversion performed to the image data is not limited to the gamut mapping, but an arbitrary conversion method may be used.

The image forming process in the image forming system 10 and a process of managing the printer 14 according to the exemplary embodiment will be described below.

In the image forming system 10, when the image to which the process such as creation, edit, and processing is performed with PC 12 is formed in the recording sheet 34 the image data of the image is transmitted in the form of the print job to the printer 14. When the printer 14 receives the image data, the printer 14 performs the image processing and the print process to the received image data.

At this point, in the printer 14, the image forming unit 38 converts the RGB signal of the image data inputted from PC 12 into the L*a*b* signal based on DLUT, and then CMS 40 provided in the image forming unit 38 converts the L*a*b* signal into the CMYK signal based on the color data conversion profile.

Then, the controller unit 18 performs the data conversion to the data of each of the color components C, M, Y, and K based on predetermined conversion parameters, and the controller unit 18 outputs the converted data to ROS 26. Therefore, the scanning and exposure is performed to each photosensitive drum 22 with the light beam emitted from ROS 26, which allows the toner image to be formed on each photosensitive drum 22 according to the image data.

The toner images formed on the photosensitive drums 22 are transferred to the transfer belt 20 while overlapped on one another, the toner images are transferred to the recording sheet 34 by the transfer device 32, the recording sheet 34 is heated and pressurized by the fixing device 36, and thereby the image is formed on the recording sheet 34 according to the image data.

The color gamut obtaining unit 42 is provided in the controller unit 18 of the printer 14. The color gamut obtaining unit 42 performs the calibration process at the predetermined timing to obtain the output characteristics of the print output unit 16, and the color gamut obtaining unit 42 updates the color data conversion profile based on the obtained output characteristics. Accordingly, the color data conversion profile is obtained according to the color gamut being reproducible at that time by the print output unit 16, and the data conversion is performed using the color data conversion profile. The color gamut information retaining unit 46 obtains and retains the color gamut information including the color data conversion profile updated by the color gamut obtaining unit 42.

PC 12 provided in the image forming system 10 can perform the bi-directional communication (bi-directional device communication) with the output device such as the printer 14 or input device. The device information obtaining unit 58 is provided in PC 12. The device information obtaining unit 58 can obtain the color gamut information retained by the color gamut information retaining unit 46 of the printer 14 at the predetermined timing.

The color gamut computing unit 60 and the comparison processing unit 62 are provided in PC 12. When the image data is transmitted to the printer 14, PC 12 confirms whether or not the printer 14 can perform the image forming process with the proper chroma to the image data to be transmitted. When PC 12 judges that the printer 14 cannot perform the image forming process with the proper chroma or desired chroma, PC 12 can issue the command for performing the setup process. That is, in the image forming system 10, PC 12 performs color (chroma) management of the image formed by the printer 14.

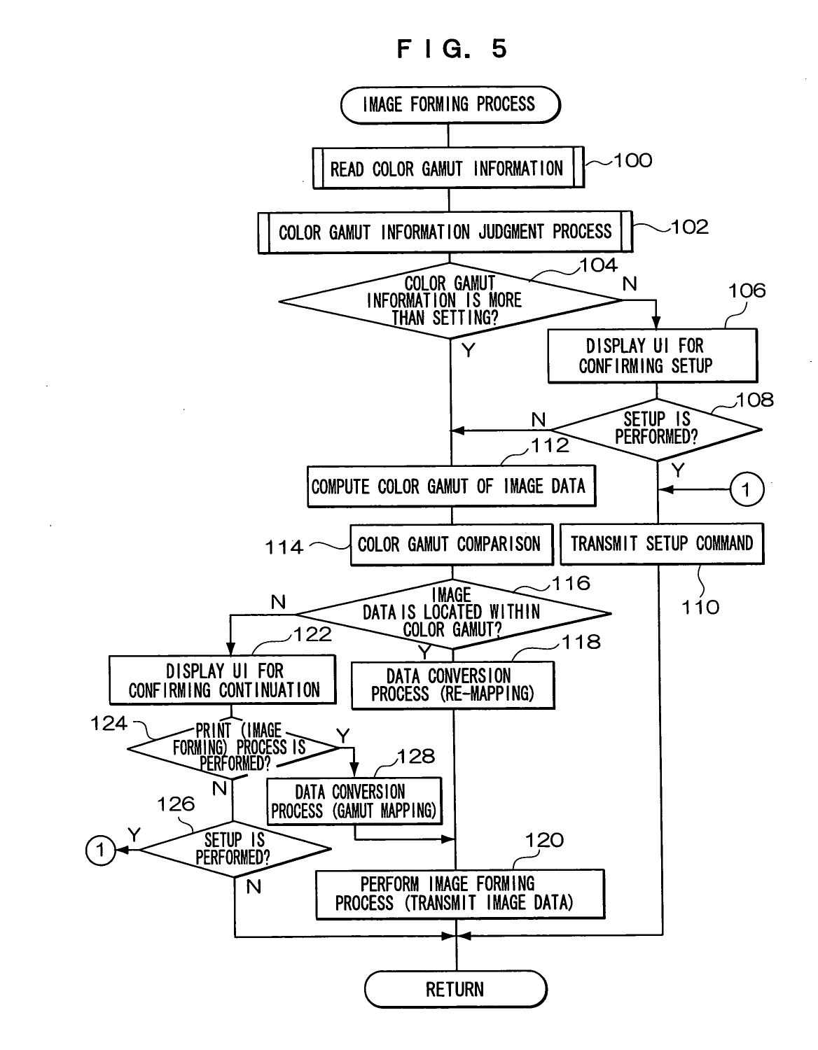

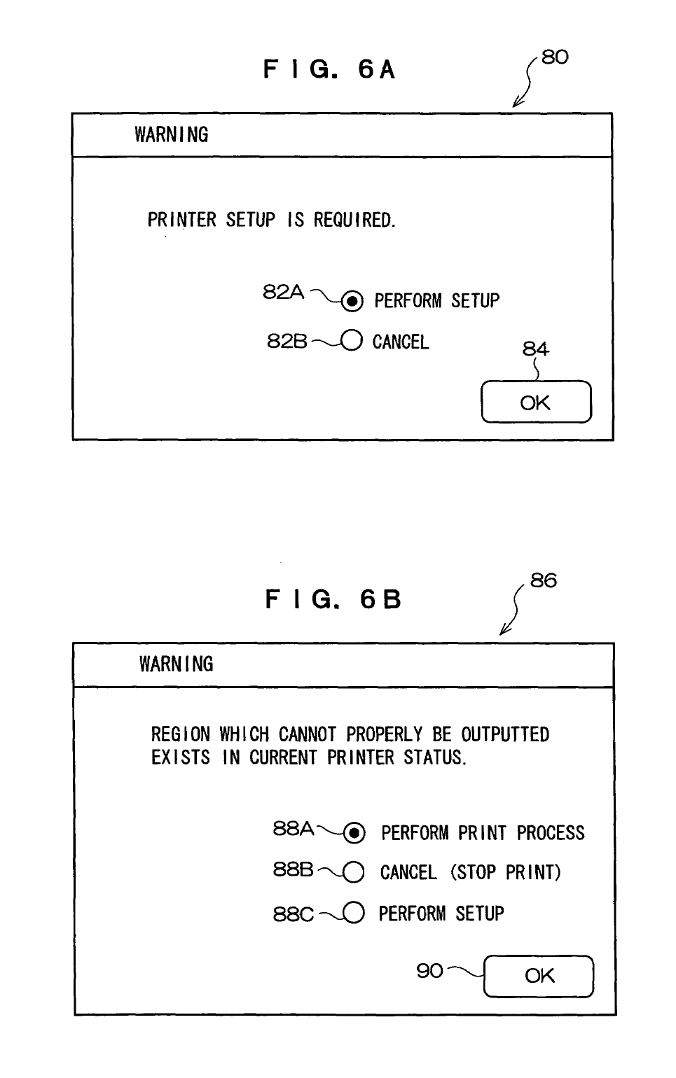

The process performed by PC 12 provided in the image forming system 10 will schematically be described with reference to FIGS. 5, 6A, and 6B.

FIG. 5 is a flowchart schematically showing the process performed by PC 12 when the image data is transmitted to the printer 14 to form the image. When the image data is transmitted to the printer 14, the flowchart of FIG. 5 is performed prior to the transmission of the image data. In Step 100, the device information obtaining unit 58 is requested for the color gamut information on the printer 14.

When the device information obtaining unit 58 is requested the color gamut information on the printer 14, the device information obtaining unit 58 requests the printer 14 to obtain the color gamut information retained by the color gamut information retaining unit 46. When the printer 14 responds to the request to output the color gamut information retained by the color gamut information retaining unit 46, the device information obtaining unit 58 reads the color gamut information and outputs the color gamut information to the comparison processing unit 62. This enables PC 12 to read the latest color gamut information at that time.

When the latest color gamut information is read, a judgment process is performed to the color gamut of printer 14 in Step 102. In the color gamut judgment process, for example, the color gamut volume is computed from the color gamut information on the printer 14, and it is confirmed whether or not the color gamut volume exceeds a predetermined reference value (setting value).

When the color gamut volume does not reach the reference value because the color gamut of printer 14 is extremely narrowed compared with the device initial state, the negative judgment is made in Step 104 and the flow goes to Step 106. In Step 106, the predetermined UI is displayed on the display using the UI unit 64, and it is confirmed whether or not the setup process is performed to return the color gamut of printer 14 to the device initial state.

FIG. 6A shows a warning confirmation window 80 which is of an example of UI used at that time. In the warning confirmation window 80, radio buttons 82A and 82B which select either the performance of the setup process of printer 14 or suspension (cancel) of the setup process are displayed while a warning message that the setup process of the printer 14 is required is displayed.

hen the radio button 82A is marked to operate an OK button 84, the setting is made such that the command for performing the setup process is issued. When the radio button 82B is marked to operate the OK button 84, the setting is made such that the setup process is suspended.

In the flowchart of FIG. 5, when the setting is made such that the setup process is performed, the affirmative judgment is made in Step 108, and the flow goes to Step 110. When the flow goes to Step 110, PC 12 issues the command for performing the setup process to the setup unit 48 of the printer 14.

When the command for performing the setup process is issued, in the printer 14, setup unit 48 performs the setup process. When the command for performing the setup process is issued, the printer 14 may start the setup process without delay after the image data is currently received or after the print process is currently performed to the image data. Preferably the PCs 12 connected to the network are notified of the start of the setup process when the setup process is performed. More preferably the setup process is performed after the permission to perform the setup process is received from each of the PCs 12 notified of the start of the setup process.

On the other hand, when the color gamut volume of the printer 14 exceeds the reference value (is not decreased to the reference value), the affirmative judgment is made in Step 104, and the flow goes to Step 112. Even in the state where the setup process is required, the process in Step 112 is also performed, when the suspension of the setup process is set to make the negative judgment in Step 108.

In Step 112, the image data outputted in the form of the print job to the printer 14 is read to compute the color gamut of the image data. That is, in Step S112, the color gamut necessary to form the proper image is computed based on the image data. In Step 114, the computed color gamut and the color gamut (color gamut information) of printer 14 are compared to each other. In Step 116, it is confirmed whether or not the color gamut of the image data is located within the color gamut of printer 14.

When the color gamut of the image data is located within the color gamut of printer 14, the affirmative judgment is made in Step 116, and the flow goes to Step 118. In Step 118, the data conversion is performed to the image data based on the color gamut of printer 14. At this point, because the color gamut of the image data is located within the color gamut of printer 14, the RGB signal of the image data in which the image having the chroma is obtained according to the image data is generated by performing the remapping to the L*a*b* signal obtained from the image data.

Then, the flow goes to Step 120, and the image forming process is performed in the printer 14 by transmitting the image data in the form of the print job to the printer 14. The reproducible color gamut becomes the device initial state immediately after the setup process is performed to the printer 14, so that the remapping process can be omitted.

On the other hand, when the color gamut of the image data is located outside the color gamut of printer 14, the negative judgment is made in Step 16 and the flow goes to Step 122. In Step 122, there is provided a notification that the color gamut of printer 14 is narrowed not to possibly obtain the image having the predetermined chroma, and an input of the next process command is required.

FIG. 6B shows a process confirmation window 86 which is of an example of UI used at that time. The message that the color gamut of the image data is located outside the color gamut of printer 14 is displayed in the process confirmation window 86. Therefore, it can be recognized that the color gamut of printer 14 is narrowed as the color gamut of the image data is located far away from the color gamut of printer 14, and it can also be recognized that the color reproduction property and the chroma are possibly decreased.

Radio buttons 88A, 88B, and 88C are provided in the process confirmation window 86, so that any one of “continuation of print process” (radio button 88A), “cancel (abort print)” (radio button 88B), and “setup process” (radio button 88C) can be selected.

The continuation of the print process is set when the radio button 88A is marked to operate an OK button 90, and the setup process is set when the radio button 88C is marked to operate the OK button 90. In the process confirmation window 86, the radio button 88B is provided by way of example, and the radio button 88B is marked to interrupt the print process. Alternatively, the selection made with the radio button 88B may be neglected.

In the flowchart of FIG. 5, it is confirmed in Step 124 whether or not the continuation of the print process is set, and it is confirmed in Step 126 whether or not the performance of the setup process is set.

When the continuation of the print process is set, the affirmative judgment is made in Step 124, and the flow goes to Step 128. In Step 128, the data conversion is performed to the image data based on the color gamut of printer 14.

In the data conversion performed in Step 128, because the color gamut of the image data is wider than the color gamut of printer 14, the gamut mapping is performed, the mapping of the L*a*b* signal obtained from the image data is performed in the color gamut of printer 14, which generates the image data in which the generation of the difference is prevented in the image hue and the like.

When the setup process is set, the affirmative judgment is made in Step 126 while the negative judgment is made in Step 124, the flow goes to Step 110, and the setup process is performed to the printer 14.

Thus, in the image forming system 10, PC 12 performs the bi-directional device communication, and PC 12 reads and retains the color gamut information as the status of the printer 14. When the image forming process is performed with the printer 14, PC 12 confirms whether or not the image can be formed with the proper chroma.

Even if the color gamut of printer 14 is narrowed, the print process is not interrupted by performing the setup process to the printer 14, when the image can be formed with the proper chroma or desired chroma with respect to the image data to which the print process is performed. That is, the setup process can be continued without performing the setup process to the printer 14.

This enables the desired image to be formed while the setup process of the printer 14 is suppressed to the minimum necessary. Furthermore, because the PC 12 can issue the command for performing the setup process to the printer 14, when the image data print process is required, there is generated no problem that the print process cannot be performed due to the performance of the setup process to the printer 14. Therefore, the decrease in productivity of the printer 14 or the articles of consumption caused by performing the setup process can be suppressed.

n the exemplary embodiment, when the image data is transmitted to the printer 14, the color gamut volume of the printer 14 is computed to judge whether or not the color gamut volume exceeds the reference value (processes from Step 102 to Step 110 of FIG. 5). However, the color gamut judgment of the printer 14 is not limited to the time during which the image data is transmitted. In addition to the time during which the print process is performed, the color gamut judgment may be performed at predetermined arbitrary timing such as start-up of PC 12, a predetermined time interval, and the calibration timing of the printer 14.

In the exemplary embodiment, the predetermined UI is displayed to perform the setup process when the color gamut of printer 14 does not reach the reference value. Alternatively, the setup process may be performed without confirmation of UI.

On the other hand, in the exemplary embodiment, when the color of the image data becomes located outside the color gamut of printer 14, namely, when the image having the color which is out of the color gamut of printer 14 exists in the image data, the negative judgment is made in Step 116, and UI is displayed to confirm whether the print process is continued or the setup process is performed in Step 122. The confirmation whether or not the print process is continued (whether or not the setup process is performed) is not limited to this exemplary embodiment, but an arbitrary criterion may be used.

For the criterion, the confirmation whether the print process is continued or the setup process is performed may be made when a ratio of the image which is out of the color gamut of printer 14 exceeds a predetermined value (for example, 10%).

For the criterion, the judgment whether or not the decrease in chroma exceeds a predetermined value in performing the print process is made by performing the data conversion such as the gamut mapping, and the confirmation whether or not the print process is continued may be made when the decrease in chroma exceeds the predetermined value.

In the exemplary embodiment, when the image data is transmitted, the update is performed (process in Step 100 of FIG. 5) by requesting the printer 14 for the color gamut information obtained by the device information obtaining unit 58 is transmitted. Alternatively, the latest color gamut information may be previously retained by obtaining and updating the color gamut information at predetermined arbitrary timing such as the start-up of PC 12 and a predetermined time interval.

In the exemplary embodiment, the confirmation whether or not the setup process is performed is made with the warning confirmation window 80, and the confirmation whether the print process is continued or the setup process is performed is made with the process confirmation window 86. However, these UIs are shown by way of example, and UI having an arbitrary configuration may be used according to the intended use.

In the exemplary embodiment, when the color gamut of the image data is located outside the color gamut of printer 14, the confirmation whether the print process is continued or the setup process is performed is made with UI. Alternatively, the confirmation with UI may be neglected by previously determining whether the print process is performed or the setup process is performed on PC 12.

In the exemplary embodiment, the color gamut volume of the printer 14 is used as the criterion whether or not the command for performing the setup process is issued. Alternatively, the judgment whether or not the setup process is performed may be made on an arbitrary condition such that the command for performing the setup process is issued when the density of each of the plural colors or at least one color is decreased below a predetermined value.

In the exemplary embodiment, the color gamut information of the printer 14 is obtained in real time to enable the image to be formed with the desired color reproduction property and chroma. Alternatively, PC 12 may perform the data conversion according to not only the color gamut but the output characteristics of the print output unit 16 by causing PC 12 to also have the function of CMS 40 of the printer 14.

In the exemplary embodiment described above, the printer 14 which is of the image forming device (print output device) is described as the output device by way of example. However, the invention can be applied not only to the printer 14 but also to the print output device and image forming device having arbitrary configurations.

The output device to which the present invention is applied is not limited to the print output device such as the printer 14, but the present invention can be applied to an output device having an arbitrary configuration in which the image forming process such as the image display is performed according to the image data.

What is claimed is:

1. An image forming system comprising:
an image processing device that carries out image processing including image formation;
an output device that forms an image according to image data within an image-formable color gamut by receiving the image data output from the image processing device;
a first color gamut information retaining component that is provided in the output device and retains first color gamut information representing the color gamut that can be formed by the output device;
a device information obtaining component that is provided in the image processing device and obtains the first color gamut information from the output device;
a color gamut information computing component that computes second color gamut information that is a necessary gamut for image formation based on the image data to be output to the output device;
a comparison component that compares the second color gamut information computed by the color gamut information computing component and the first color gamut information obtained by the device information obtaining component; and
a judgment component that judges based on the comparison result of the comparison component whether or not to output the image data to the output device to perform an image forming process.

2. The image forming system of claim 1, wherein it is judged to perform the image forming process to the image data when the color gamut specified by the second color gamut information is included in the color gamut specified by the first color gamut information.

3. The image forming system of claim 1, wherein it is judged to perform the image forming process to the image data when at least a portion of the color gamut specified by the second color gamut information is located outside the color gamut specified by the first color gamut information and, at the same time, the second color gamut information satisfies a condition previously set with respect to the first color gamut information.

4. The image forming system of claim 1, further comprising a data conversion component that performs data conversion to the image data based on the first color gamut information and the second color gamut information when the judgment component judges to output the image data to the output device.

5. The image forming system of claim 4, wherein, when the color gamut specified by the second color gamut information is included in the color gamut specified by the first color gamut information, the data conversion component performs the data conversion to the image data according to the color gamut in a device initial state and to the color gamut based on the first color gamut information.

6. The image forming system of claim 4, wherein, when at least a portion of the color gamut specified by the second color gamut information is located outside the color gamut specified by the first color gamut information, the data conversion component performs the data conversion such that the color gamut of the image data is included in the color gamut specified by the first color gamut information.

7. The image forming system of claim 1, wherein, if the output device includes a setup component that performs a setup process, the judgment component judges whether or not to perform the setup process, in which the color gamut of the image that can be formed by the output device is returned to the device initial state.

8. The image forming system of claim 7, wherein it is judged to perform the setup process when at least a portion of the color gamut specified by the second color gamut information is located outside the color gamut specified by the first color gamut information and, at the same time, the second color gamut information does not satisfy a condition which is previously set with respect to the first color gamut information.

9. The image forming system of claim 7, wherein it is judged to perform the setup process when the color gamut based on the first color gamut information is located outside a predetermined reference value.

10. The image forming system of claim 7, wherein
the image processing device includes a display input component that displays the comparison result of the comparison component and is able to input a process command for the output device, and
the judgment component makes a judgment based on the process command input to the display input component.

11. A method of managing an output device comprising:
forming an image based on image data within an image-formable color gamut by an output device receiving the image data output from an image processing device that can perform image processing including image formation;
performing a setup process, in which the image-formable color gamut is returned to a device initial state based on an external command;
the image processing device obtaining first color gamut information that represents the color gamut that can be formed by the output device;
second color gamut information necessary to form the image data being obtained when the image data is transmitted to the output device;
the color gamut based on the first color gamut information being compared with the color gamut based on the device initial state or the second color gamut information, and
judging whether or not to perform the setup process of the output device based on the comparison result, using the image processing device.

12. The management method of claim 1, wherein it is judged to perform the setup process of the output device when at least a portion of the second color gamut information is located outside the first color gamut information.

13. The management method of claim 11, wherein it is judged whether or not to perform the setup process of the output device based on a reference value that is set based on the first color gamut information and color gamut information in the device initial state.

14. The management method of claim 11, wherein verification whether or not to perform the setup process is carried out when the judgment to perform the setup process of the output device is made.
